(19) United States
(12) Patent Application Publication
(10) Pub. No.: US 2018/0316637 A1
(43) Pub. Date: Nov. 1, 2018

(54) CONVERSATION LENS FOR CONTEXT

(71) Applicant: Microsoft Technology Licensing, LLC, Redmond, WA (US)

(72) Inventor: Patrick Desjardins, Redmond, WA (US)

(21) Appl. No.: 15/583,034

(22) Filed: May 1, 2017

(51) Int. Cl. H04L 12/58; H04L 29/06; G06F 3/0484

(52) U.S. Cl. CPC H04L 51/046; G06F 3/04842; H04L 51/16; H04L 65/403

(57) ABSTRACT

Non-limiting examples of the present disclosure describe a user interface adapted to provide a real-time visualization of context for a message thread. A message input is received through a user interface of a collaborative team environment. The message input is received from a first user in a message thread of the collaborative team environment. The message input is analyzed to identify context data associated with the message input. Context data comprises previous message data associated with a second user of the message thread. A real-time visualization of the context data is generated. As an example, the real-time visualization comprises: data analytics for correspondence of the previous message data between the first user and the second user, an identification of a most recent communication received from the second user and a contextual suggestion for the analyzed message input. The real-time visualization is provided in the message thread.

### BACKGROUND

In a world where communication takes a central place, with hundreds of different people to reach, it become harder and harder to keep track of previous conversations and gain access to data needed to answer messages quickly and accurately. If a user wishes to retrieve previous context for a message, the user is required to manually to search for past conversation, email or meeting to identify subjects/topics and people that a user is communicating with. This poses challenges for the user, ultimately due to time requirements, whether a user is able to remember specific contexts to search for and generally relating to a user experience/satisfaction with an application/service.

### SUMMARY

Non-limiting examples of the present disclosure describe enhancement of a user interface, which is adapted to provide a real-time visualization of context for a message thread. As an example, a user interface of an application/service is enhanced to provide a user with past data and contextual suggestions pertaining to a message being written in a message thread. An exemplary application/service is a collaborative team environment that enables users to communicate collaboratively in teams/groups, for example, on a project by project basis. While examples described herein reference a collaborative team environment, it is to be understood that processing operations and user interface examples described herein extend to any type of application/service that provides message threads which include multiple users.

In one example, a message input is received through a user interface of a collaborative team environment. The message input may be received from a first user in a message thread of the collaborative team environment. The message input is analyzed to identify context data associated with the message input. Context data may comprise previous message data associated with a second user of the message thread. A real-time visualization of the context data may be generated. As an example, the real-time visualization comprises: data analytics for correspondence of the previous message data between the first user and the second user. The real-time visualization may further comprise an identification of a most recent communication received from the second user and a contextual suggestion for the analyzed message input. As described herein, additional data may also be included in the real-time visualization. The real-time visualization may be provided in the message thread of the collaborative team environment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an exemplary method related to management of real-time visualizations of data within an application/service with which aspects of the present disclosure may be practiced.

FIGS. 2A and 2B provide processing device views illustrating exemplary real-time visualizations with which aspects of the present disclosure may be practiced.

FIG. 3 is a block diagram illustrating an example of a computing device with which aspects of the present disclosure may be practiced.

FIGS. 4A and 4B are simplified block diagrams of a mobile computing device with which aspects of the present disclosure may be practiced.

FIG. 5 is a simplified block diagram of a distributed computing system in which aspects of the present disclosure may be practiced.

### DETAILED DESCRIPTION

Non-limiting examples of the present disclosure describe enhancement of a user interface, which is adapted to provide a real-time visualization of context for a message thread. As an example, a user interface of an application/service is enhanced to provide a user with past data and contextual suggestions pertaining to a message being written in a message thread. An exemplary real-time visualization provides a real-time glimpse (e.g. visual form) of previous communication history for a message being written or replied to within a message thread (e.g. conversation). An exemplary user interface, that presents a real-time visualization, is adapted to enhance processing efficiency and a user interaction with an application/service, among other benefits. For instance, a user is assisted with knowing and having immediate access to a context surrounding subject entities including users involved in a collaborative communication. In one example, data analytics for communication between users (across a specific application and/or a suite of applications) can be provided to help a user gauge communication patterns, reply/responses, etc., as well as provide context for a message and suggestions for content to include in a message. Collectively aggregating and presenting such data greatly enhances operating efficiency for a user by presenting relevant data at the fingertips of the user without requiring a user to go search for and analyze such data (if even feasible for the user to do so on their own). Further, exemplary visualizations of context data for a message can be updated in real-time, providing a user with up to data information

An exemplary application/service is a collaborative team environment that enables users to communicate collaboratively in teams/groups, for example, on a project by project basis. While examples described herein reference a collaborative team environment, it is to be understood that processing operations and user interface examples described herein can extend to any type of application/service that provides message threads which include multiple users. A collaborative team environment is a team-based groupware solution that helps people work together collectively while located remotely from each other. Collaborative team environments enable real time collaboration synchronously as well as asynchronously. As an example, collaborative team environments can be configured to include functionality such as: multimodal communication, sharing of data including electronic calendars, collective writing messages and communication in message threads, e-mail handling, shared database access, and management of electronic meetings where each person is able to see and display information for others, among other examples. An exemplary collaborative team environment may further be extensible to interface with other applications/services including social networking services and other applications/services associated with a platform (e.g. Microsoft® Office 365® that may provide a suite of applications).

Accordingly, the present disclosure provides a plurality of technical advantages including but not limited to: an improved user interface for an application/service, generation and management of real-time visualizations that provide context for message input, more efficient operation of processing devices (e.g., saving computing cycles/computing resources) in collecting, aggregating and presenting context for a message input, improving user interaction with exemplary application/services and extensibility to access and integrate data from different applications/services of a distributed network to improve application processing, among other examples.

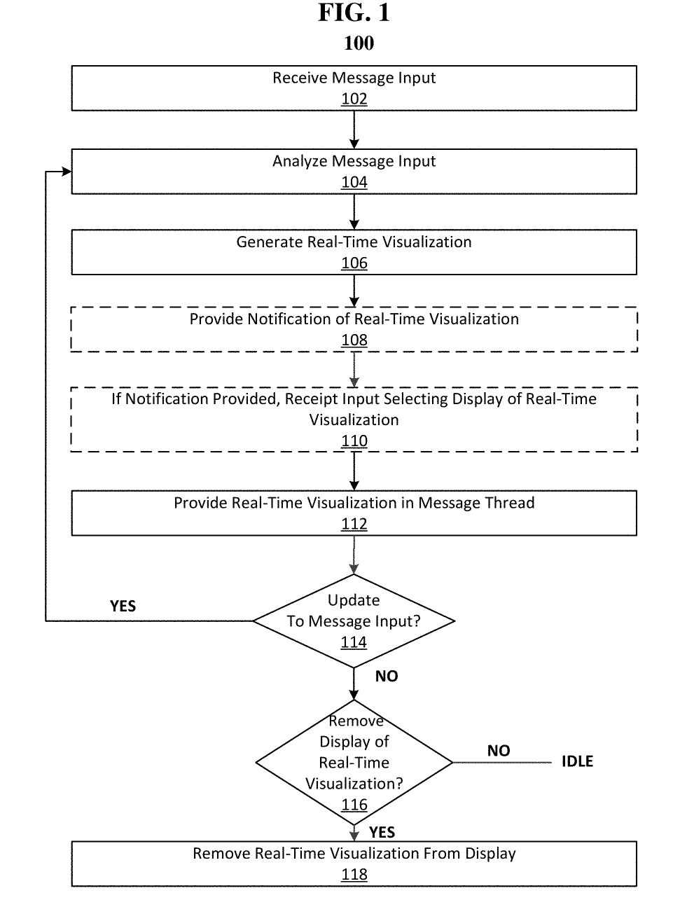

FIG. 1 is an exemplary method 100 related to management of real-time visualizations of data within an application/service with which aspects of the present disclosure may be practiced. Method 100 describes examples relations to generation and management of an exemplary real-time visualization providing context data within an application/service. For ease of understanding, examples described herein relate to an application/service that is configured as a collaborative team environment. While examples described herein reference a collaborative team environment, it is to be understood that processing operations and user interface examples described herein can extend to any type of application/service that provides message threads which include multiple users.

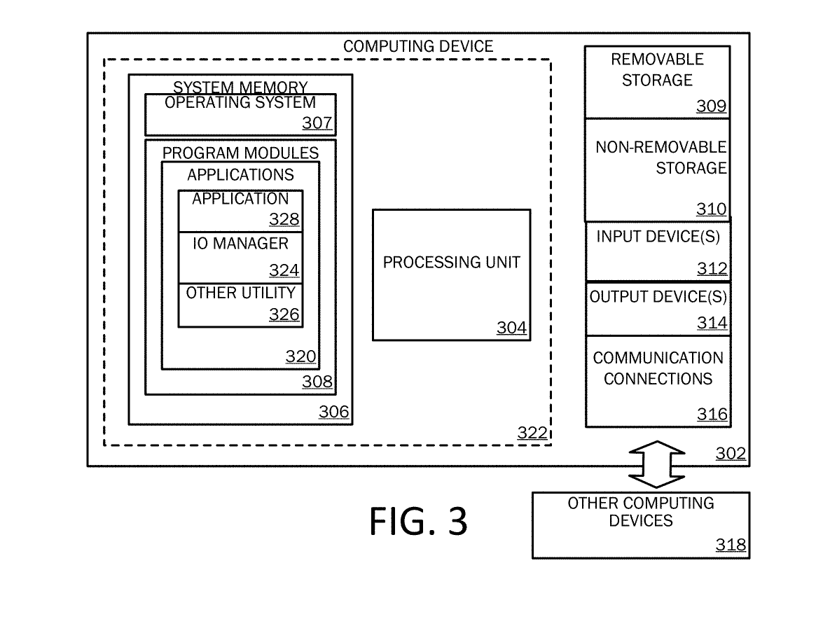

As an example, method 100 may be executed by an exemplary processing device and/or system such as those shown in FIGS. 3-5. In examples, method 100 may execute on a device comprising at least one processor configured to store and execute operations, programs or instructions. Operations performed in method 100 may correspond to operations executed by a system and/or service that execute computer programs, application programming interfaces (APIs), neural networks or machine-learning processing, among other examples. As an example, processing operations executed in method 100 may be performed by one or more hardware components. In another example, processing operations executed in method 100 may be performed by one or more software components. In some examples, processing operations described in method 100 may be executed by one or more applications/services associated with a web service that has access to a plurality of application/services, devices, knowledge resources, etc. Processing operations described in method 100 may be implemented by one or more components connected over a distributed network, where an exemplary collaborative team environment may be a distributed service accessed via network connection.

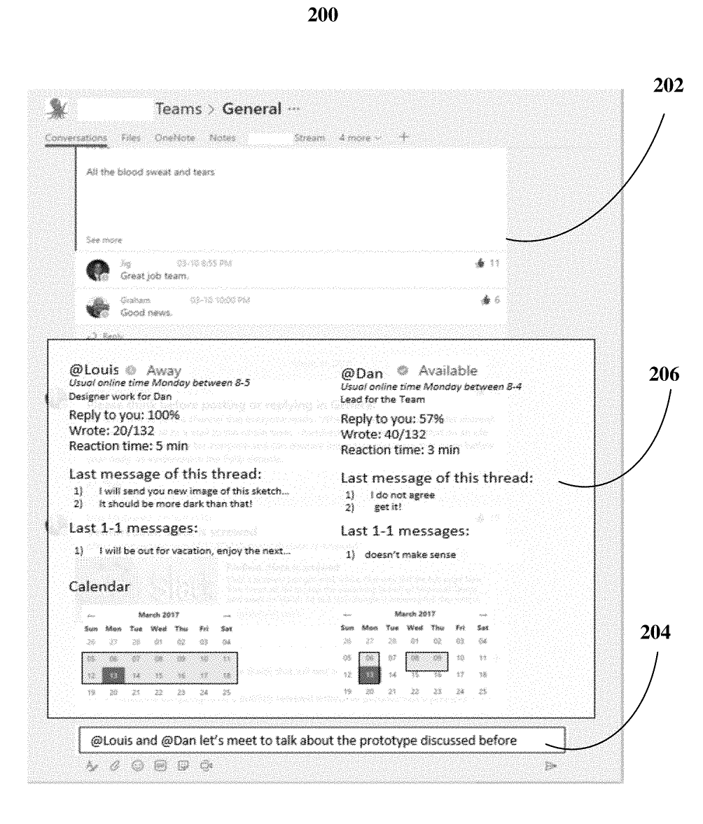

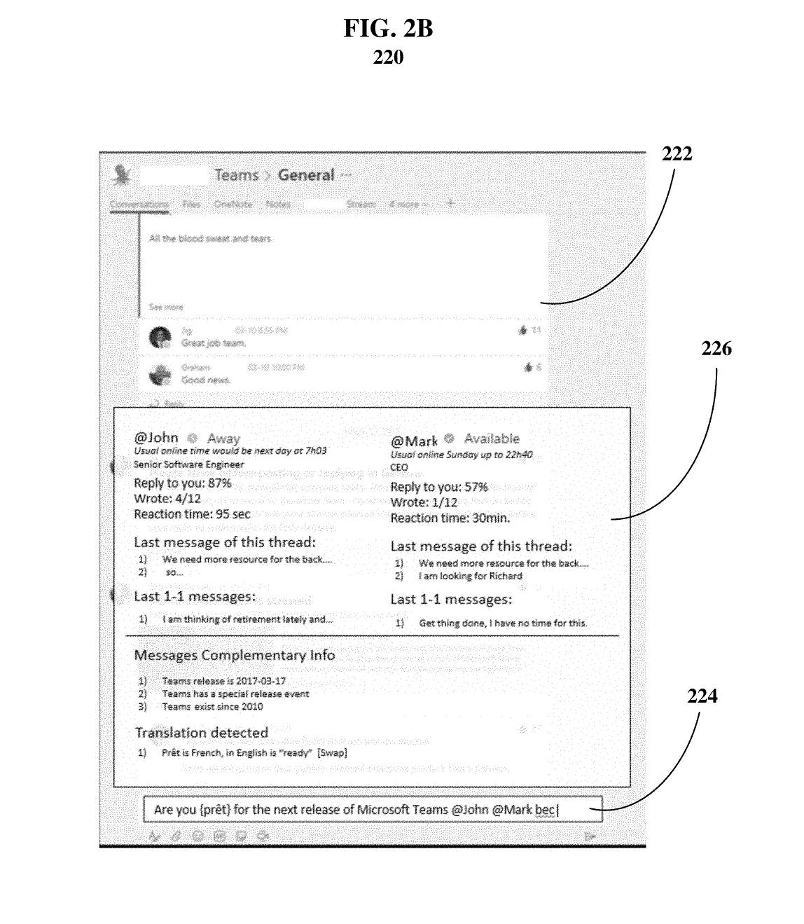

Method 100 begins at processing operation 102, where message input is received. As referenced above, message input may be received through an exemplary application/service such as a collaborative team environment. As an example, a message input is received (processing operation 102) through a user interface (UI) of a collaborative team environment. Message input may be entered through a message field, which is UI feature configured for entering data. Examples related to a message field and message input that triggers generation of an exemplary real-time visualization are shown in FIGS. 2A and 2B.

The message input may be received (processing operation 102) from a first user in a message thread of the collaborative team environment. For instance, a message thread may be a specific conversation (e.g. dedicated topic) that is used for communication with other users (e.g. a group or team of users) within the collaborative team environment. In one example, a message thread may be a component of a specific communication channel within the collaborative team environment. An exemplary collaborative team environment may be configured to enable a group of users (e.g. team) to set specific communication channels related to individual subjects/tasks/projects. An exemplary message thread may be specific to a single communication channel or may cross-reference multiple communication channels.

Flow may proceed to processing operation 104, where the received message input may be analyzed to identify context data associated with the message input. Analysis of context of a message input may comprise applying one or more input understanding models in coordination with knowledge repositories (including data stores for user data associated with a collaborative team environment) and/or knowledge graphs to evaluate semantic understanding, subject/entities, etc. In one example, input understanding processing for contextual analysis of a message input may be further executed by a web search engine service (e.g. Bing®) and/or an intelligent personal assistant service (e.g. Cortana®). Models, knowledge repositories and associated components for analysis of message input and input understanding processing are known to one skilled in the art. In analyzing a message input, components may be applied to determine intent and/or interests of the user. Processing operations for determining intent and user interests are known to one skilled in the art. Components used for analyzing message input may be incorporated within the collaborative team environment or the message input may be transmitted to other components or applications/services to execute analysis of the message input where results are returned to the collaborative team environment for generation of an exemplary real-time visualization.

In processing operation 104, context data identified through analysis of the message input may be any data that is utilized to provide contextual understanding for a received message input. As an example, context data comprises previous message data associated with one or more threads of the collaborative team environment. Previous message data may be correspondence in any form including but not limited to: emails, text messages, chat or conferencing communications, file data (including video and/or audio files), among other examples. For instance, previous message data may be associated with a second user (or multiple other users of a message thread) of the collaborative team environment, where the previous message data comprises message data from correspondence between the first user and the second user across message threads of the collaborative team environment. In further examples, previous message data may comprise message data related to correspondence between the first user and the second user (or multiple users) collected from a suite of productivity services or other applications/services affiliated with a platform (e.g. Microsoft®, Apple®, Google®, etc.). For example, in addition to communications within a collaborative team environment, a user and another user may correspond frequently in other applications/services (e.g. notes applications, spreadsheet applications, word processing applications, social networking services, etc.). Communications across the collaborative team environment and/or suite of productivity services may be analyzed (e.g. telemetric analysis), where a user interface of the collaborative team environment may be configured to provide a real-time representation of data analytics pertaining to previous correspondence between specific users.

Moreover, context data may further comprise result data retrieved from evaluation of message input. For example, message input may be analyzed (e.g. through input understanding processing) and further search using web search engine services and/or intelligent personal assistant services. Result data retrieved from such searching may be utilized to generate contextual suggestions for the message input, for example, that may be included in a real-time visualization generated for the message input. Other types of data may also be analyzed to determine contextual suggestions to include within an exemplary real-time visualization including but not limited to: previous message data, and user signal data (e.g. device specific and/or affiliated with a user account of the user). In one instance, results for contextual suggestions may be retrieved (e.g. from web search services and/or intelligent personal assistant services) where additional user signal data (retrieved based on analysis of a user account and/or device of a user) may be utilized to filter the content returned as contextual suggestions. User signal data may comprise any data relating to actions (explicit or implicit) that are taken by a user, which may be evaluated to determine intent and/or interests of the user. Processing operations for determining intent and user interest are known to one skilled in the art. The team collaborative environment may be programmed to execute telemetric analysis of user signal data in generation of an exemplary real-time visualization. Alternatively, the team collaborative environment may interface with other applications/services (e.g. of a platform) to retrieve telemetric data for understanding user intent and interests.

The collaborative team environment is configured to detect and evaluate the message input. In one example, analysis (processing operation 104) of message input by the collaborative team environment comprises the detection of triggers, which may foster specific types of analysis of the message input and a context for the message input. Examples of triggers are subsequently provided. Data associated with such triggers can be analyzed to determine how to generate and tailor an exemplary real-time visualization for the message input.

There are many possible triggers that an exemplary collaborative team environment is configured to detect and analyze. In one example, if during the message input, the user types a delimiting symbol (e.g. @ for a mention) with the name of the person following the delimiting symbol, analysis can be focused on information such as who is being mentioned as well as a context in which a user is being mentioned. The information can be analyzed to determine if the mentioned user was in the thread previously, and if yes, what was the last message or correspondence. This is interesting if a lot of messages were written and that it may be hard to see what was the last message of that specific user. Analysis of such information can also consider a real-time state of a message thread and what information/data is being viewed in the message thread. For instance, generation of an exemplary real-time visualization can selectively determine what information to display (e.g. might make a determination to display such information if the mentioned user is not already in view within the message thread).

In another example, the use of delimiting symbols and/or text or gaps left between respective characters may provide indications of for specific processing. For instance, if a user enters a delimiting symbol of “{ }” that may be a trigger that analysis of the message input is to yield translation or additional information for content. This is useful for people that have not mastered the main language that is being used. As an example, translation services may be offered to enable the user to convert message input to different languages or translate a received message. In an alternative example, the user could write: “This is a good {histoire} my friend” and have the panel showing that “histoire” is “story” in English and offer to update the message input on behalf of the user. That is, contextual suggestions provided through an exemplary real-time visualization may be applicable to update message input and/or other content of the message thread (e.g. generate a new email, setup a meeting, etc.).

Another trigger is specific words in the received message input (e.g. identified through written or spoken input). For example, keywords or reference to specific words/terms can be flagged based on an analysis of a specific message thread, conversation or channel within the collaborative team environment. As identified above, modeling may be applied for language understanding evaluation, subject/entity evaluation, knowledge graphs for association of words/terms, etc. For example, if someone start writing “The next release of the product will be . . . ”, the team collaborative environment is configured to be smart enough to know that the users may be referring to a specific product release related to a team of users (e.g. associated with the message thread in the collaborative team environment). As another example, if someone says, within the message thread, “Like discussed in the channel XYZ about the build” than the team collaborative environment is configured to be able to search into the channel XYZ and find reference about “build” and show up data. The idea is that the writer shouldn't have to leave the textbox to have context about what he refers to. Such functionality improves intelligence of the collaborative team environment and increases efficiency for the user while creating a richer user experience when using the collaborative team environment where the user does not have to manually search for specific content or try to recreate a context to explain what is being referenced. In further examples, an order of words being used, phrasing or punctuation may be identified and analyzed to assist in identifying context of a message input, user intent and user interest.

Yet another trigger is when people are talking about organizing something. Some words like “meeting” can trigger the electronic calendar of the people mentioned in the message being written. For example, “@Alan and @Bob we should meet soon” which can provide an indication to display an electronic calendar of specific people when the writer type meet. An electronic calendar for a specific user can be provided in the real-time visualization generated for the message input.

Analysis of message input may be utilized to generate an exemplary real-time visualization providing contextual analysis for a message input. Flow may proceed to processing operation 106, where an exemplary real-time visualization is generated. Illustrative examples of exemplary real-time visualizations are shown in FIGS. 2A and 2B. For ease of understanding, consider an example where a message input is directed to a specific user (or mentions a specific user. That is, a first user (writing the message input) is communicating with a second user of a message thread. As an example, the real-time visualization may comprise: data analytics for correspondence of the previous message data between users of the message thread such as the first user and the second user. If there are additional users mentioned (or involved in the message thread), data analytics may be further presented that identifies correspondence between the user and the additional users (in an individual or collective manner). The real-time visualization may further comprise an identification of a most recent communication received from the second user and a contextual suggestion for the analyzed message input. As described herein, additional data may also be included in the real-time visualization. For instance, the real-time visualization may comprise: an identification of a most recent communication from the message thread and/or an identification of recent topics discussed in the message thread of the collaborative team environment.

In examples, data analytics for message correspondence between users (or groups of users) may be presented relating to a user that is in view of a current message thread or otherwise mentioned in a message input. For instance, this may be useful to help a user identify reply patterns of another user, frequency of replies, what type of response to expect, etc. In an alternative example, if the thread is not all visible (e.g. maybe out of screen or collapsed), the collaborative team environment may be configured to provide data analytics for correspondence with the mentioned user. Examples of data analytics are subsequently described and non-limiting examples of data analytics, presented within an exemplary real-time visualization, are illustrated in FIGS. 2A and 2B.

In one instance, data analyzed, and ultimately displayed in an exemplary real-time visualization, may comprise the number of messages and replies for the mentioned person. For example, the user may be able to see that the mentioned person only replied 3 times on 42. This is something that is shown only if the user already replied into an existing thread and may not show on a new conversation or message thread. However, in some examples, message correspondence with a mentioned user may pertain to correspondence across a plurality of application/services. For instance, mentioned users may be associated with a user account (e.g. of a platform that provides a user with single sign-on access to a plurality of applications/services).

Other analytical information that may be displayed comprises information about the user (e.g. job title and who this one report to, bio information, etc.). Further, additional information that can be analyzed and displayed comprises: information as to when a user was last online, patterns of when the user is online/offline based on previous access, data showing the rate of user reply as well as data showing when a user typically replies (e.g. so a user may be able to expect a reply). For example, a data analytic, may be generated and presented in an exemplary real-time visualization, that highlights that a mentioned user normally replies to messaging user 82% of time. Also, other statistics like the median time that the user replies in specific instances such as when the user is mentioned in message thread. For example, “8 min” (i.e. representing that the user takes an average of 8 minutes to reply to a message they were mentioned in). However, it is to be understood that data analytics can be generated and presented for any type of related to correspondence between users (e.g. the normal rate of reply from a user across all types of communications).

Additional analysis executed on previous message content is identification of one-on-one correspondence between the user and the mentioned user (or group of users). In the case that previous conversation occurred, the last few messages can be displayed to remind the writer who mentioned the person in some previous context from the past. Another data possible is to indicate if the person is normally available during the time he is mentioned.

As referenced above, an exemplary real-time visualization may comprise one or more contextual suggestions for the analyzed message input. Results data retrieved from knowledge repositories and other resources (e.g. web search services, intelligent personal assistant services, etc.) may be used in conjunction with any of previous message data, and user signal data (e.g. device specific and/or affiliated with a user account of the user) to generate contextual suggestions. As an example, a contextual suggestion may comprise but is not limited to: a language translation for the message input, a link to content of a social networking service, an electronic calendar of one or more of the first user and the second user, and results data retrieved from data resources (including web search services and intelligent personal assistant services), among other examples.

In some alternative examples of method 100, flow may proceed to processing operation 108. At processing operation 108, the user interface of the collaborative team environment is configured to provide a notification that the real-time visualization is available for display. That is, in some instances the real-time visualization does not automatically appear. However, in other examples, an exemplary real-time visualization is automatically provided for a user. In an instance where the collaborative team environment is configured to provide a selectable notification (e.g. based on user preference) for display of a real-time visualization, flow may proceed to processing operation 110. If a notification is provided, processing operation 110 comprises detecting receipt of input indicating display of the real-time visualization.

In any example, flow of method 100 proceeds to processing operation 112, where the real-time visualization is provided through the collaborative team environment. In examples where a notification is provided, processing operation 112 may comprise providing the real-time visualization as the pop-up user interface feature based on a selection input associated with the notification. In other examples, an exemplary real-time visualization is automatically provided based on generation (processing operation 106) of the real-time notification. The user interface of the collaborative team environment is configured to provide the real-time visualization as a pop-up user interface feature that displays, in the message thread, in proximity to a message entry field for receiving the message input. For instance, the real-time visualization may appear around the user's cursor, where message input is being or has been entered. In some examples, the user interface may be configured to receive gesture control to show/hide a generated real-time visualization. For example, the user may enter a touch input or voice command to management display of the real-time visualization. In other examples, UI features for application control of the real-time visualization may be provided through the user interface of the collaborative team environment. In alternative examples, a real-time visualization may be generated and provided to a user (or group of users) asynchronously, for example, through an email, text message, etc. Such an example may be useful to continually provide users with up to date information about a message thread and communication patterns within the message thread.

Flow of method 100 may proceed to decision operation 114, where it is determined whether there is an update to the message input. Update to the message input may occur through the user changing entered input (e.g. in the message entry field) or selection of context within a displayed real-time visualization, among other examples. If the message input is updated, flow of method 100 branches YES and processing returns to processing operation 104, where the message input is re-analyzed. If necessary, subsequent processing may yield update to an exemplary real-time visualization. If the message input is not updated, flow of method 100 branches NO and processing proceeds to decision operation 116.

At decision operation 116, it is determined whether display of the real-time visualization is to be removed. As an example, the user interface is configured to close (or hide) the real-time visualization when the message is sent or if the user manually decides to close the real-time visualization (e.g. through UI control or commands). If display of the real-time visualization is not to be removed, flow of method 100 branches NO and processing remains IDLE. If display of the real-time visualization is to be removed, flow of method 100 branches YES and processing proceeds to processing operation 118, where the real-time visualization is removed from display.

FIGS. 2A and 2B provide processing device views illustrating exemplary real-time visualizations with which aspects of the present disclosure may be practiced. Processing operations described for generation and management of an exemplary real-time visualization are described in at least the foregoing description of method 100 (FIG. 1).

FIG. 2A illustrates processing device view 200, which is a user interface example an exemplary collaborative team environment executing on a computing device (as referenced herein). Processing device view 200 illustrates an exemplary message thread 202 being accessed within the collaborative team environment. As can be seen in processing device view 200, a user enters a message input 204 into a message entry field of the message thread 202. For instance, the user (e.g. writer) provides input that comprises delimiting symbols (e.g. @) directed to specific users for setting up a meeting (e.g. keyword of meet) in a context of a discussion regarding a prototype. An exemplary real-time visualization 206 is generated for the message input. As can be seen in processing device view 200, the real-time visualization 206 comprises: information for the mentioned users (e.g. Louis & Dan), data analytics regarding analyze of previous correspondence and interaction with the individual users, identification of a last messages within the message thread 202, identification of last one-on-one correspondence with the respective users and contextual suggestions that display electronic calendars for the respective users (e.g. Louis & Dan). The real-time visualization 206 is displayed prominently for the user and does not obstruct the message input 204 or message entry field within the message thread 202.

FIG. 2B illustrates processing device view 220, which is another user interface example an exemplary collaborative team environment executing on a computing device (as referenced herein). Processing device view 220 illustrates an exemplary message thread 222 being accessed within the collaborative team environment. As can be seen in processing device view 220, a user enters a message input 224 into a message entry field of the message thread 222. For instance, the user (e.g. writer) provides input that comprises delimiting symbols (e.g. { } and related character input “wet”) in addition to delimiting symbols that direct the communication to specific users (e.g. @John and @Mark) in a context of a discussion a product release. An exemplary real-time visualization 226 is generated for the message input. As can be seen in processing device view 220, the real-time visualization 226 comprises: information for the mentioned users (e.g. John & Mark), data analytics regarding analyze of previous correspondence and interaction with the individual users, identification of a last messages within the message thread 222, identification of last one-on-one correspondence with the respective users and contextual suggestions that comprise message complementary information (e.g. related to the product release) as well as translation detection for a French word “wet”. The real-time visualization 226 is displayed prominently for the user and does not obstruct the message input 204 or message entry field within the message thread 222.

FIGS. 3-5 and the associated descriptions provide a discussion of a variety of operating environments in which examples of the invention may be practiced. However, the devices and systems illustrated and discussed with respect to FIGS. 3-5 are for purposes of example and illustration and are not limiting of a vast number of computing device configurations that may be utilized for practicing examples of the invention, described herein.

FIG. 3 is a block diagram illustrating physical components of a computing device 302, for example a mobile processing device, with which examples of the present disclosure may be practiced. Among other examples, computing device 302 may be an exemplary computing device configured for generation and management of exemplary real-time visualizations for context data as described herein. In a basic configuration, the computing device 302 may include at least one processing unit 304 and a system memory 306. Depending on the configuration and type of computing device, the system memory 306 may comprise, but is not limited to, volatile storage (e.g., random access memory), non-volatile storage (e.g., read-only memory), flash memory, or any combination of such memories. The system memory 306 may include an operating system 307 and one or more program modules 308 suitable for running software programs/modules 320 such as IO manager 324, other utility 326 and application 328. As examples, system memory 306 may store instructions for execution. Other examples of system memory 306 may store data associated with applications. The operating system 307, for example, may be suitable for controlling the operation of the computing device 302. Furthermore, examples of the invention may be practiced in conjunction with a graphics library, other operating systems, or any other application program and is not limited to any particular application or system. This basic configuration is illustrated in FIG. 3 by those components within a dashed line 322. The computing device 302 may have additional features or functionality. For example, the computing device 302 may also include additional data storage devices (removable and/or non-removable) such as, for example, magnetic disks, optical disks, or tape. Such additional storage is illustrated in FIG. 3 by a removable storage device 409 and a non-removable storage device 310.

As stated above, a number of program modules and data files may be stored in the system memory 306. While executing on the processing unit 404, program modules 408 (e.g., Input/Output (I/O) manager 324, other utility 326 and application 328) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 3 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 402 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 302 may also have one or more input device(s) 312 such as a keyboard, a mouse, a pen, a sound input device, a device for voice input/recognition, a touch input device, etc. The output device(s) 314 such as a display, speakers, a printer, etc. may also be included. The aforementioned devices are examples and others may be used. The computing device 404 may include one or more communication connections 316 allowing communications with other computing devices 318. Examples of suitable communication connections 316 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 306, the removable storage device 309, and the non-removable storage device 310 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 302. Any such computer storage media may be part of the computing device 302. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

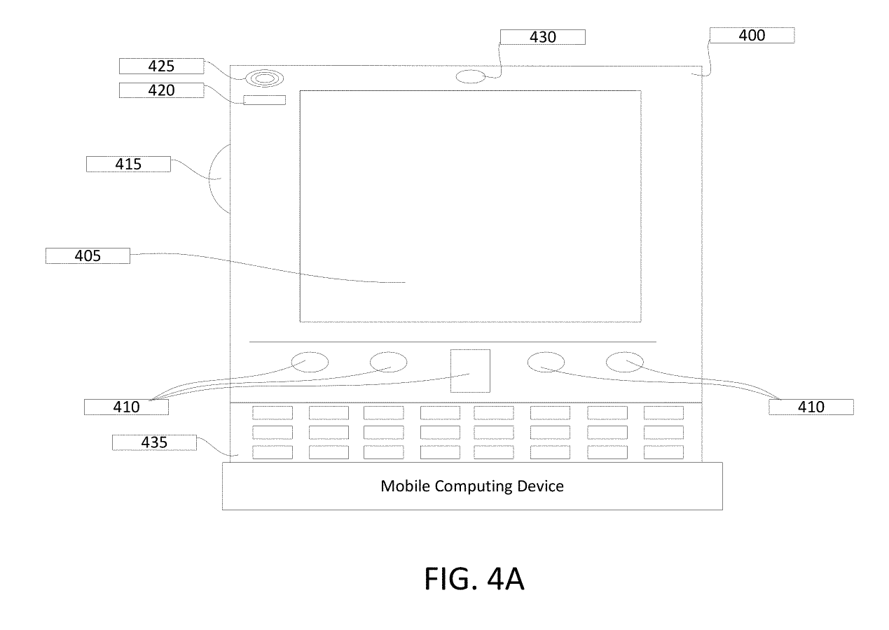

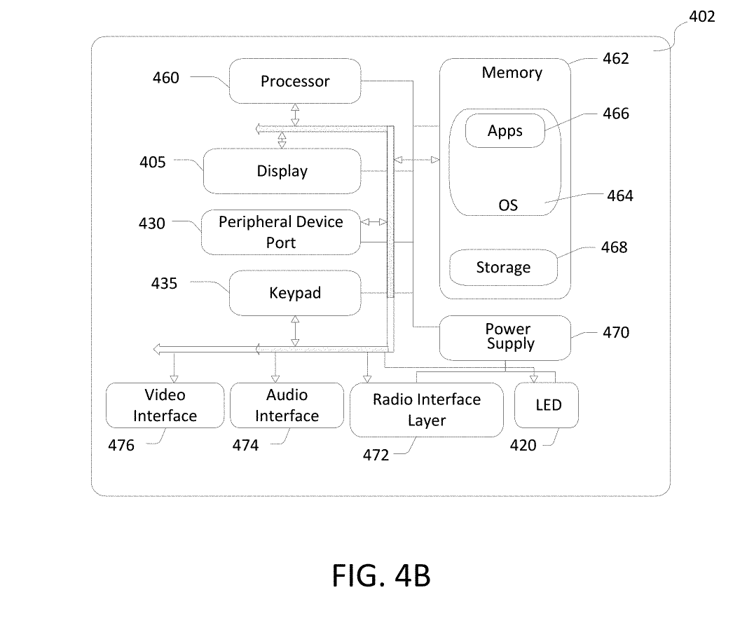

FIGS. 4A and 4B illustrate a mobile computing device 400, for example, a mobile telephone, a smart phone, a personal data assistant, a tablet personal computer, a phablet, a slate, a laptop computer, and the like, with which examples of the invention may be practiced. Mobile computing device 400 may be an exemplary computing device configured for generation and management of exemplary real-time visualizations for context data as described herein. Application command control may be provided for applications executing on a computing device such as mobile computing device 400. Application command control relates to presentation and control of commands for use with an application through a user interface (UI) or graphical user interface (GUI). In one example, application command controls may be programmed specifically to work with a single application. In other examples, application command controls may be programmed to work across more than one application. With reference to FIG. 4A, one example of a mobile computing device 400 for implementing the examples is illustrated. In a basic configuration, the mobile computing device 400 is a handheld computer having both input elements and output elements. The mobile computing device 400 typically includes a display 405 and one or more input buttons 410 that allow the user to enter information into the mobile computing device 400. The display 405 of the mobile computing device 400 may also function as an input device (e.g., touch screen display). If included, an optional side input element 415 allows further user input. The side input element 415 may be a rotary switch, a button, or any other type of manual input element. In alternative examples, mobile computing device 400 may incorporate more or less input elements. For example, the display 405 may not be a touch screen in some examples. In yet another alternative example, the mobile computing device 400 is a portable phone system, such as a cellular phone. The mobile computing device 400 may also include an optional keypad 435. Optional keypad 435 may be a physical keypad or a “soft” keypad generated on the touch screen display or any other soft input panel (SIP). In various examples, the output elements include the display 405 for showing a GUI, a visual indicator 420 (e.g., a light emitting diode), and/or an audio transducer 425 (e.g., a speaker). In some examples, the mobile computing device 400 incorporates a vibration transducer for providing the user with tactile feedback. In yet another example, the mobile computing device 400 incorporates input and/or output ports, such as an audio input (e.g., a microphone jack), an audio output (e.g., a headphone jack), and a video output (e.g., a HDMI port) for sending signals to or receiving signals from an external device.

FIG. 4B is a block diagram illustrating the architecture of one example of a mobile computing device. That is, the mobile computing device 400 can incorporate a system (i.e., an architecture) 402 to implement some examples. In one examples, the system 402 is implemented as a “smart phone” capable of running one or more applications (e.g., browser, e-mail, calendaring, contact managers, messaging clients, games, and media clients/players). In some examples, the system 402 is integrated as a computing device, such as an integrated personal digital assistant (PDA), tablet and wireless phone.

One or more application programs 466 may be loaded into the memory 462 and run on or in association with the operating system 464. Examples of the application programs include phone dialer programs, e-mail programs, personal information management (PIM) programs, word processing programs, spreadsheet programs, Internet browser programs, messaging programs, and so forth. The system 402 also includes a non-volatile storage area 468 within the memory 462. The non-volatile storage area 468 may be used to store persistent information that should not be lost if the system 402 is powered down. The application programs 466 may use and store information in the non-volatile storage area 468, such as e-mail or other messages used by an e-mail application, and the like. A synchronization application (not shown) also resides on the system 402 and is programmed to interact with a corresponding synchronization application resident on a host computer to keep the information stored in the non-volatile storage area 468 synchronized with corresponding information stored at the host computer. As should be appreciated, other applications may be loaded into the memory 462 and run on the mobile computing device (e.g. system 402) described herein.

The system 402 has a power supply 470, which may be implemented as one or more batteries. The power supply 470 might further include an external power source, such as an AC adapter or a powered docking cradle that supplements or recharges the batteries.

The system 402 may include peripheral device port 430 that performs the function of facilitating connectivity between system 402 and one or more peripheral devices. Transmissions to and from the peripheral device port 430 are conducted under control of the operating system (OS) 464. In other words, communications received by the peripheral device port 430 may be disseminated to the application programs 466 via the operating system 464, and vice versa.

The system 402 may also include a radio interface layer 472 that performs the function of transmitting and receiving radio frequency communications. The radio interface layer 472 facilitates wireless connectivity between the system 402 and the “outside world,” via a communications carrier or service provider. Transmissions to and from the radio interface layer 472 are conducted under control of the operating system 464. In other words, communications received by the radio interface layer 472 may be disseminated to the application programs 566 via the operating system 464, and vice versa.

The visual indicator 420 may be used to provide visual notifications, and/or an audio interface 474 may be used for producing audible notifications via the audio transducer 425 (as described in the description of mobile computing device 400). In the illustrated example, the visual indicator 420 is a light emitting diode (LED) and the audio transducer 425 is a speaker. These devices may be directly coupled to the power supply 470 so that when activated, they remain on for a duration dictated by the notification mechanism even though the processor 460 and other components might shut down for conserving battery power. The LED may be programmed to remain on indefinitely until the user takes action to indicate the powered-on status of the device. The audio interface 474 is used to provide audible signals to and receive audible signals from the user. For example, in addition to being coupled to the audio transducer 425 (shown in FIG. 4A), the audio interface 474 may also be coupled to a microphone to receive audible input, such as to facilitate a telephone conversation. In accordance with examples of the present invention, the microphone may also serve as an audio sensor to facilitate control of notifications, as will be described below. The system 402 may further include a video interface 476 that enables an operation of an on-board camera 430 to record still images, video stream, and the like.

A mobile computing device 400 implementing the system 402 may have additional features or functionality. For example, the mobile computing device 400 may also include additional data storage devices (removable and/or non-removable) such as, magnetic disks, optical disks, or tape. Such additional storage is illustrated in FIG. 4B by the non-volatile storage area 468.

Data/information generated or captured by the mobile computing device 400 and stored via the system 402 may be stored locally on the mobile computing device 400, as described above, or the data may be stored on any number of storage media that may be accessed by the device via the radio 472 or via a wired connection between the mobile computing device 400 and a separate computing device associated with the mobile computing device 400, for example, a server computer in a distributed computing network, such as the Internet. As should be appreciated such data/information may be accessed via the mobile computing device 400 via the radio 472 or via a distributed computing network. Similarly, such data/information may be readily transferred between computing devices for storage and use according to well-known data/information transfer and storage means, including electronic mail and collaborative data/information sharing systems.

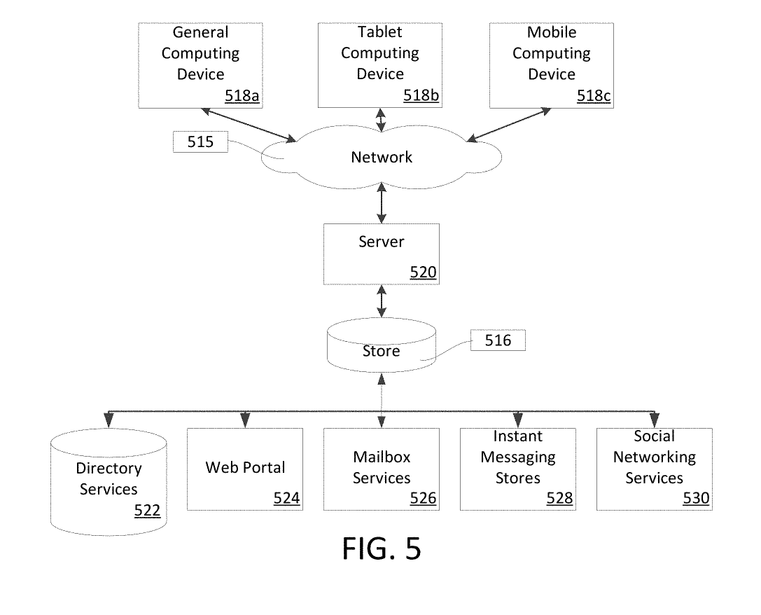

FIG. 5 illustrates one example of the architecture of a system for providing an application that reliably accesses target data on a storage system and handles communication failures to one or more client devices, as described above. The system of FIG. 5 may be an exemplary system configured for generation and management of exemplary real-time visualizations for context data as described herein. Target data accessed, interacted with, or edited in association with programming modules 308 and/or applications 320 and storage/memory (described in FIG. 3) may be stored in different communication channels or other storage types. For example, various documents may be stored using a directory service 522, a web portal 524, a mailbox service 526, an instant messaging store 528, or a social networking site 530, IO manager 324, other utility 326, application 328 and storage systems may use any of these types of systems or the like for enabling data utilization, as described herein. A server 520 may provide storage system for use by a client operating on general computing device 302 and mobile device(s) 400 through network 515. By way of example, network 515 may comprise the Internet or any other type of local or wide area network, and a client node may be implemented for connecting to network 515. Examples of a client node comprise but are not limited to: a computing device 302 embodied in a personal computer, a tablet computing device, and/or by a mobile computing device 400 (e.g., mobile processing device). As an example, a client node may connect to the network 515 using a wireless network connection (e.g. WiFi connection, Bluetooth, etc.). However, examples described herein may also extend to connecting to network 515 via a hardwire connection. Any of these examples of the client computing device 302 or 400 may obtain content from the store 516.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
receiving, through a user interface of a collaborative team environment, a message input from a first user in a message thread of the collaborative team environment;
analyzing the message input to identify context data associated with the message input, wherein the context data comprises previous message data associated with a second user of the message thread;
generating a real-time visualization of the context data, wherein the real-time visualization comprises:
data analytics for correspondence of the previous message data between the first user and the second user,
an identification of a most recent communication received from the second user, and
a contextual suggestion for the analyzed message input; and
providing, through the user interface of the collaborative team environment, the real-time visualization within the message thread of the collaborative team environment.

2. The method of claim 1, wherein the previous message data comprises message data from correspondence between the first user and the second user across message threads of the collaborative team environment.

3. The method of claim 2, wherein the previous message data comprises message data correspondence between the first user and the second user collected from a suite of productivity services.

4. The method of claim 1, wherein the real-time visualization comprises: an identification of a most recent communication from the message thread.

5. The method of claim 1, wherein the real-time visualization comprises: an identification of recent topics discussed in the message thread of the collaborative team environment.

6. The method of claim 1, wherein the contextual suggestion is one or more selected from a group consisting of: a language translation for the message input, a link to content of a social networking service and an electronic calendar of one or more of the first user and the second user.

7. The method of claim 1, wherein the user interface is configured to provide the real-time visualization as a pop-up user interface feature that displays, in the message thread, in proximity to a message entry field for receiving the message input.

8. The method of claim 7, further comprising: providing, in the message thread, a notification that the real-time visualization is available and the providing displays the real-time visualization as the pop-up user interface feature based on a selection input associated with the notification.

9. A system comprising:
at least one processor; and
a memory, operatively connected with the at least one processor, storing computer-executable instructions that, when executed by the at least one processor, causes the at least one processor to execute a method that comprises:
receiving, through a user interface of a collaborative team environment, a message input from a first user in a message thread of the collaborative team environment;
analyzing the message input to identify context data associated with the message input, wherein the context data comprises previous message data associated with a second user of the message thread;
generating a real-time visualization of the context data, wherein the real-time visualization comprises:
data analytics for correspondence of the previous message data between the first user and the second user,
an identification of a most recent communication received from the second user, and
a contextual suggestion for the analyzed message input; and
providing, through the user interface of the collaborative team environment, the real-time visualization within the message thread of the collaborative team environment.

10. The system of claim 9, wherein the previous message data comprises message data from correspondence between the first user and the second user across message threads of the collaborative team environment.

11. The system of claim 10, wherein the previous message data comprises message data correspondence between the first user and the second user collected from a suite of productivity services.

12. The system of claim 9, wherein the real-time visualization comprises: an identification of a most recent communication from the message thread.

13. The system of claim 9, wherein the real-time visualization comprises: an identification of recent topics discussed in the message thread of the collaborative team environment.

14. The system of claim 9, wherein the contextual suggestion is one or more selected from a group consisting of: a language translation for the message input, a link to content of a social networking service and an electronic calendar of one or more of the first user and the second user.

15. The system of claim 9, wherein the user interface is configured to provide the real-time visualization as a pop-up user interface feature that displays, in the message thread, in proximity to a message entry field for receiving the message input.

16. The system of claim 15, where the method, executed by the at least one processor, further comprises: providing, in the message thread, a notification that the real-time visualization is available and the providing displays the real-time visualization as the pop-up user interface feature based on a selection input associated with the notification.

17. A computer-readable medium storing computer-executable instructions that, when executed by at least one processor, causes the at least one processor to execute a method comprising:
receiving, through a user interface of a collaborative team environment, a message input from a first user in a message thread of the collaborative team environment;
analyzing the message input to identify context data associated with the message input, wherein the context data comprises previous message data associated with a second user of the message thread;
generating a real-time visualization of the context data, wherein the real-time visualization comprises:
data analytics for correspondence of the previous message data between the first user and the second user,
an identification of a most recent communication received from the second user, and
a contextual suggestion for the analyzed message input; and
providing, through the user interface of the collaborative team environment, the real-time visualization within the message thread of the collaborative team environment.

18. The computer-readable medium of claim 17, wherein the previous message data comprises message data from one or more selected from a group consisting of: correspondence between the first user and the second user across message threads of the collaborative team environment and correspondence between the first user and the second user collected from a suite of productivity services.

19. The computer-readable medium of claim 17, wherein the real-time visualization comprises: an identification of a most recent communication from the message thread.

20. The computer-readable medium of claim 17, wherein the contextual suggestion is one or more selected from a group consisting of: a language translation for the message input, a link to content of a social networking service and an electronic calendar of one or more of the first user and the second user.
